(19) United States
(12) Patent Application Publication
(10) Pub. No.: US 2020/0037025 A1
(43) Pub. Date: Jan. 30, 2020

(54) SYSTEMS AND METHODS FOR SHARING DEVICES THAT PROVIDE CONTENT & INTERACTIVE TELEVISION SERVICES

(71) Applicant: SONIFI Solutions, Inc., Sioux Falls, SD (US)

(72) Inventors: Derin Michael Zerr, Kahului, HI (US); Joshua H. Pulford, Sioux Falls, SD (US); Eric Aasen, Sioux Falls, SD (US)

(21) Appl. No.: 16/523,496

(22) Filed: Jul. 26, 2019

Related U.S. Application Data
(60) Provisional application No. 62/703,595, filed on Jul. 26, 2018.

(51) Int. Cl. H04N 21/4363; H04N 21/4408; H04N 21/41; H04N 21/235

(52) U.S. Cl. CPC H04N 21/43637; H04N 21/2351; H04N 21/4126; H04N 21/4408

(57) ABSTRACT

A method includes receiving, via a first network, a request to pair an end user environment to a headend. The headend includes a plurality of content providing devices. The method includes selecting, in response to the request, a content providing device of the plurality of content providing devices based on one or more factors. The method includes pairing, via the first network, the end user environment with the selected content providing device. The method includes receiving, via a second network, content according to input from the end user environment, and providing, via the first network, the content from the selected content providing device to the end user environment.

### CROSS-REFERENCE TO RELATED APPLICATIONS

This application claims the benefit of U.S. Provisional Patent Application Ser. No. 62/703,595, filed Jul. 26, 2018, the entire disclosure of which is hereby incorporated herein by reference for all that it teaches and for all purposes.

### FIELD

Example embodiments are generally directed to systems and methods for sharing devices that provide content (e.g., audio and/or video) and interactive television (TV) services.

### BACKGROUND

Increasingly, content, such as movies and television shows, is delivered to users on demand over digital networks. In addition, the distribution of content has expanded to include intermediary devices (or content providing devices) that provide content from a number of content providers to end users. These intermediary devices have the ability to interface with content delivery systems and to output video, other content, and interactive services to end users.

Where multiple output devices (e.g., displays) are potentially available in the vicinity of a user device (e.g., a mobile phone), selecting and using an appropriate content providing device can become problematic, particularly in a hotel or other hospitality or Multiple Dwelling Unit setting. For example, in many hospitality settings, device isolation, which prevents user devices from discovering other devices, is a requirement. Such requirements may lead each user having a dedicated content providing device, which is costly and inefficient, particularly in a hospitality setting where hundreds of content providing devices may be needed. Thus, it is desired to develop systems and/or methods that allow sharing of output devices between multiple potential users.

### SUMMARY

According to at least one example embodiment, instead of placing a content providing device on each TV, an array of such devices are placed in a centralized location to conserve resources. There would be another piece(s) of hardware that would take the video out of a shared device (e.g. Chromecast) via HDMI, remove the HDCP encryption, encode into H.264 or other compressed video format, re-encrypt the signal with hospitality standard (e.g., Pro:Idiom), then either deliver to the room via IP or QAM(coax). The shared content providing devices would not only be for video casting, but also used as interactive television engines. They would receive keys from a user's IR remote control over one or more of three methods (Ethernet IP, Wireless IP, or Coax b-LAN). Additionally or alternatively, the user may employ an application running on a smart phone, smart TV, tablet, etc. that enables the same communication as a remote control. Accordingly, example embodiments provide a solution for headend interactivity that also allows for headend-based casting.

It is important to note that any content providing device could be used. For instance, a PC running a web browser, Apple TV, Amazon Fire TV, a game console, etc.

A user's device must be registered with the system controller in order for casting to work across a hotel network. Once the registration is complete, the user's device is paired with their current room and allows casting to any television in that room for compatible applications. The registration and pairing require certain pieces of information to be transmitted to the system server. The system server gets this information transmitted to it via web service calls/APIs from different external sources depending on registration method and site configuration. The system server maintains the pairing association between a user's device, room, and shared players (e.g. Chromecast devices or “over the top” (OTT) devices) in the centralized location until instructed to destroy that association. The system server may use a room number along with the IP and/or MAC addresses of the user's device in order to register that device and pair it with the user's (e.g. the guest's) room. The system server, once a pairing is established, forwards the correct network traffic between a user's device and the shared player, allowing casting of content to the shared player. The system server maintains a table of shared players and creates a lookup table of device MAC addresses paired with shared players at any given time. All web service calls to or from the system server should contain basic information such as date, time, a sequence/packet identifier, etc.

According to at least one example embodiment, the shared players may be dynamically assigned and/or unassigned based on current resource usage. For example, if a user request to use a shared player exceeds the number of available shared players, then the request may be denied. When a different user is finished using a shared player, then that shared player becomes available for the request that was denied or another request.

The preceding is a simplified summary of example embodiments to provide an understanding of some aspects of example embodiments. This summary is neither an extensive nor exhaustive overview of inventive concepts and its various aspects, embodiments, and/or configurations. It is intended neither to identify key or critical elements nor to delineate the scope but to present selected concepts in a simplified form as an introduction to the more detailed description presented below. As will be appreciated, other aspects, embodiments, and/or configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

Additional features and advantages of example embodiments will become more readily apparent from the following description, particularly when taken together with the company drawings.

### BRIEF DESCRIPTION OF THE DRAWINGS

FIG. 1 is a block diagram depicting components of a system in accordance with at least one example embodiment;

FIG. 2 is a block diagram depicting components of a system in accordance with at least one example embodiment;

FIG. 3 is a block diagram depicting components of a system in accordance with at least one example embodiment;

FIG. 4 is a block diagram illustrating an example structure of the system controller and application server according to at least one example embodiment;

FIG. 5 is a block diagram illustrating an example structure of the content providing device according to at least one example embodiment;

FIG. 6 illustrates a messaging diagram in accordance with at least one example embodiment; and

FIG. 7 is a flow chart illustrating a method according to at least one example embodiment.

### DETAILED DESCRIPTION

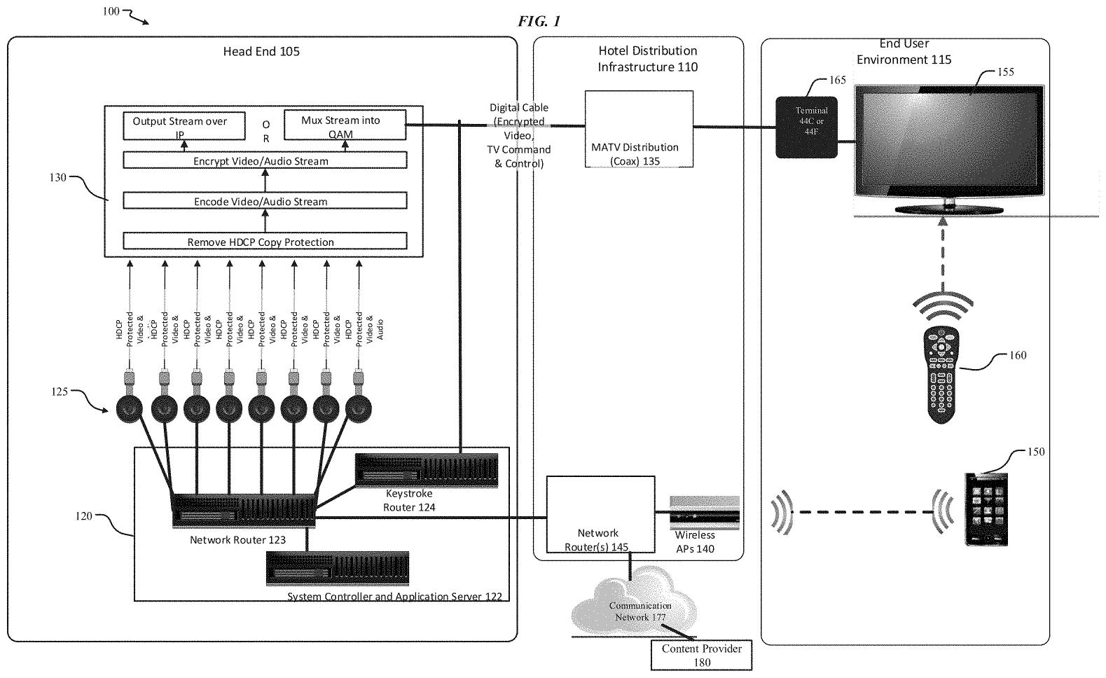

FIG. 1 is a block diagram depicting components of a system 100 in accordance with embodiments of the present disclosure. In more detail, FIG. 1 shows a headend 105 (e.g., of a hospitality environment such as a hotel), a distribution infrastructure 110 (e.g., of the hospitality environment), and an end user environment 115 (e.g., a guest room of the hotel).

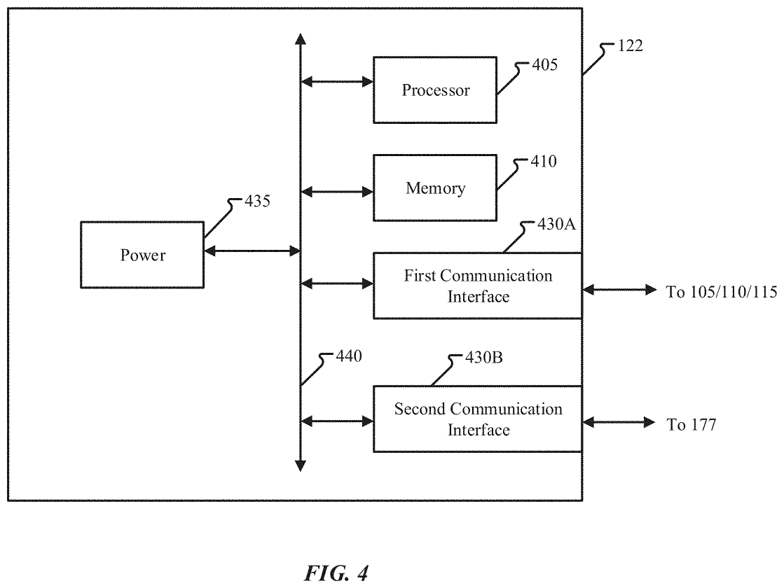

The headend 105 may include a headend manager 120, a plurality of content providing devices (or shared players) 125, and a converter 130. The headend 105 may be on-site within a hospitality environment, for example, in a service closet of a hotel. The headend manager 120 controls operation of the system 100 and may include a system controller and application server (or controller) 122, a network router 123 to send/receive signals to one or more other routers in the system 100, and a keystroke router 124 to detect input from a user in the end user environment 115 (e.g., input from the control instrument 160). The system controller and application server 122 may control the operation of headend 105 and its interaction with the distribution infrastructure 110 and the end user environment 115. An example structure of the system controller and application server 122 is described in more detail below with reference to FIG. 4. Although various elements of the headend 105 are illustrated as separate entities, it should be appreciated that one or more of the elements in headend 105 may be integrated with one another and/or included in a same housing if desired. For example, the system controller and application server 122, the network router 123, and the keystroke router 124 are illustrated as separate entities, but it should be appreciated that these elements may be integrated and/or included in a single housing if desired.

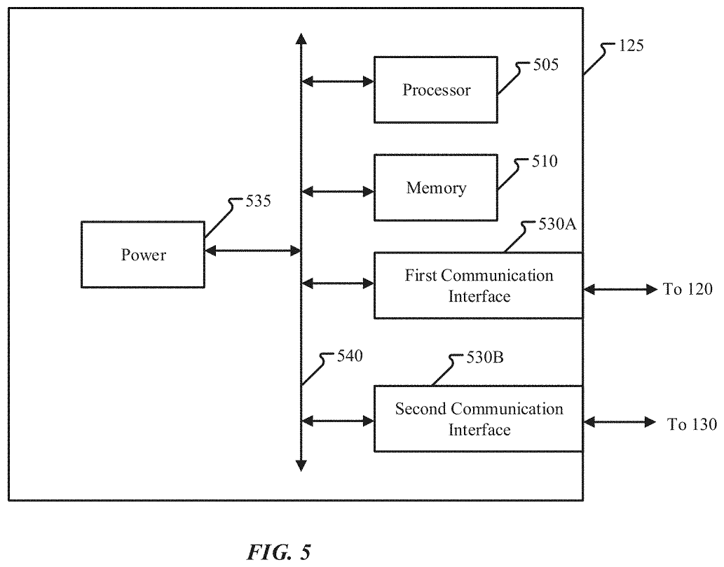

As shown, the plurality of content providing devices 125 are connected to the network router 123, which in turn is connected to the system controller and application server 122 that controls which content providing devices 125 are in use by which users in the end user environment 115. The content providing devices 125 may include one or more applications for streaming audio and/or video content from a content provider(s) 180 (e.g., a host server). An example structure of a content providing device 125 is described in more detail below with reference to FIG. 5.

The keystroke router 124 receives signals from the display 155 that are based on keystrokes on the control instrument 160, and the keystroke router 124 translates the received signals into commands for the system controller and application server 122. For example, it should be understood that the keystroke router 124 may include hardware and/or software for translating received signals at particular frequencies into control signals for the system controller and application server 122 in any known manner.

The network router 123 is also coupled to one or more network routers 145 of the distribution infrastructure 110. The network routers 123 and 145 may include hardware (e.g., inputs, outputs, wired connections, etc.) and/or software for routing signals between themselves, the content providing devices 125, the system controller and application server 122, the keystroke router 124, the access points 140, etc.

The converter 130 includes one or more components to remove high-bandwidth digital content protection (HDCP) from high-definition multimedia interface (HDMI) signals output by the content providing devices 125 (e.g., using a proprietary device that removes HDCP, or other known means for removing HDCP), encode/compress the resulting signals with another format (e.g., MPEG-2, H.264, H.265, etc.), encrypt the encoded/compressed signals with a desired encryption algorithm (e.g., Pro:Idiom or the like), and output the encrypted signals to the distribution infrastructure 110 using a known protocol or delivery scheme, such as internet protocol (IP) (e.g., IPv6), quadrature amplitude modulation (QAM), or the like. In FIG. 1, the converter 130 utilizes QAM to output the encrypted signals in order to be compatible with a Master Antenna TV (MATV) system 135 in the distribution infrastructure 110. The converter 130 may be a single device or several if desired.

Here, it should be appreciated that elements of the headend 105 may exist in a single location (e.g., one room) or be spread throughout a variety locations (e.g., multiple rooms) according to design preferences.

The distribution infrastructure 110 may include one or more elements associated with distributing content in a hospitality setting. For example, if the hospitality setting is a hotel, then the distribution infrastructure 110 may include a (MATV) 135 network or system (e.g., coaxial cable network) or the like for distributing content to the end user environment 115, one or more wireless access points (APs) 140 for communicating with the end user environment 115, and one or more network routers 145 for communicating with the headend 105 and the communication network 177. The wireless APs 140 may be wireless routers including any known hardware and/or software for communicating with devices according to at least one wireless protocol (e.g., WiFi with any version in the 802.11 family of standards). The one or more network routers 145 may include any known hardware and/or software desired for communicating with the communication network 177. For example, the one or more network routers 145 may include optical fiber connections or other suitable wired/wireless connections to the communication network 177. As illustrated in FIG. 1, the communication network 177 facilitates communication between the content provider 180 and the one or more network routers 145. One example of the communication network 177 is the Internet. The content provider 180 may be an entity that provides audio and/or video content to the content providing devices 125 upon request by authorized requestors. The one or more network routers 145, wireless APs 140, and/or MATV network 135 may be spread throughout the hospitality environment as desired.

The end user environment 115 may include one or more user devices 150 (e.g., mobile devices) that connect with the distribution infrastructure 110 (e.g., with the one or more wireless APs) over WiFi using an SSID(s) of the APs 140. The end user environment 115 may include one or more displays 155 for displaying content provided by content providing devices 125, and one or more control instruments (e.g., remote controls) 160 to control various aspects of the displays 155 (e.g., channel, volume, display settings, etc.). The end user environment 115 may further include a terminal element 165 for enabling communication between the keystroke router 124 and the one or more displays 155. The terminal element 165 may be, for example, a set top box (STB) that translates signals passing between the one or more displays 155 and the MATV network 135 so that communication is possible between the headend 105 and the end user environment 115. Here, it should be understood that the terminal element 165 may be excluded or bypassed if the incoming/outgoing signals to/from the one or more displays 155 are already in a desired format (e.g., when the display 155 has a b-LAN terminal or ethernet technology embedded inside). It should be further understood that the system 100 may include additional end user environments 115 (e.g., multiple guest rooms) having the same or similar architecture as that shown in FIG. 1 for connecting with the distribution infrastructure 110.

In operation, the system 100 may allow for a user to pair the mobile device 150 with a particular one of the content providing devices 125 via a device-specific code presented on the display 155, an application programming interface (API) that includes a user loyalty number, etc. Additionally or alternatively, the user may activate a “menu” button on the control instrument 160, which causes the system controller and application server 122 to automatically pair a content providing device 125 to a particular display 155. Then, the user may interact with applications of the content providing device 125 through control instrument 160. In any event, pairing may include querying the system controller and application server 122 for connection to one of the content providing devices 125, the system controller and application server 122 selecting one of the content providing devices 125 based on desired factors (e.g., availability of the content providing devices 125, access permissions associated with the user (for example, if the user is a loyalty member, then access may be free, and if not, then access may include providing authorization for a charge), etc.), and an acknowledgement by the system controller and application server 122 that a particular content providing device 125 has been successfully selected.

Upon pairing of the mobile device 150 and/or the display 155 to a selected one of the content providing devices 125, the user may control the functionality of the selected content providing device 125 to present desired content sent from the selected content providing device 125 to the display 155 under control of the mobile device 150 and/or the control instrument 160. For example, the mobile device 150 may allow for casting and associated control of content from an application on the mobile device 150 to the display 155. Additionally or alternatively, the control instrument 160 may allow for the user to navigate applications of the selected content providing device 125 to select and view content from applications of the selected content providing device 125 (e.g., where the selected content providing device 125 streams content from the content provider 180 (e.g., Netflix)). In other words, the mobile device 150 and/or the control instrument 160 allows the user to interact with applications of the selected content providing device 125 as if the selected content providing device 125 was plugged into the display 155 itself. Stated yet another way, casting from the mobile device 150 to the display 155 through the selected content providing device 125 or casting from the selected content providing device 125 to the display 155 under control of the mobile device 150 use the same headend 105. Here, it should be appreciated that a number of the content providing devices 125 included for a particular hospitality setting is a design parameter selected based on empirical evidence and/or preference. For example, the number of devices for a particular hospitality setting may be based on an average number of guests per night and/or statistics/estimates associated with a number of guests that actually use the content providing device 125 during their stay.

In accordance with at least some example embodiments, pairing between a mobile device 150 and a content providing device 125 is performed in connection with a request for a pairing code that is entered on the mobile device 150, where the pairing code may be displayed on the display 155 and/or the mobile device 150. For example, a particular implementation of a system controller and application server 122 or an additional headend server which is operable to provide on-demand or other programming and interactive television functions via the display 155 can provide the menu system that enables a user to request a pairing code. When the user selects a menu item in the interactive television system to request a pairing between the mobile device 150 of the user and the content providing device 125, the headend system 105 makes a request for a pairing code that is created by a web service call to the system controller and application server 122. The information sent to the system controller and application server 122 to generate the pairing code includes a site identifier, a guest ID, and TV terminal ID where the code was requested from. The pairing code is returned from the system controller and application server 122 to the headend system 105, which displays the pairing code to the guest via the display 155. Additionally or alternatively, the user may activate a “menu” button on the control instrument 160, which causes the system controller and application server 122 to automatically pair a content providing device 125 to a particular display 155. Then, the user may interact with applications of the content providing device 125 through control instrument 160.

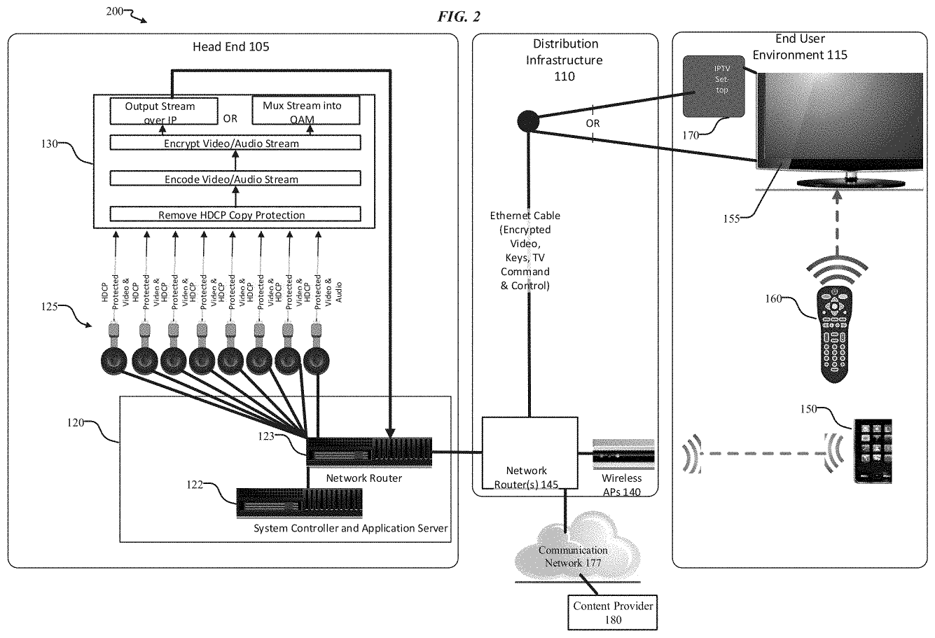

FIG. 2 is a block diagram depicting components of a system 200 in accordance with embodiments of the present disclosure. In more detail, FIG. 2 includes the same elements as FIG. 1 except the headend manager 120 does not include a keystroke router 124, the distribution infrastructure 110 does not include the MATV network 135, and the end user environment 115 includes an optional IPTV set top box 170 instead of the terminal element 165. As shown, the set top box 170 may include an audio/video connection to the display device 155. In addition, the system 200 of FIG. 2 delivers content and receives user commands via Ethernet cables instead of the coax cables in FIG. 1. Accordingly, the converter 130 sends an encrypted content stream over, for example, IPv6 to the network router 123. The network router 123 then sends the encrypted content stream over Ethernet to set top box 170 for decryption prior to display on display 155. If the display 155 has a built-in IPTV client, then the set top box 170 may be omitted or bypassed. As noted by the distribution infrastructure 110, signals travel between the display 155 and the headend 105 via Ethernet. These signals may include encrypted content, key input to the control instrument 160, and/or display command and control. Here, it should be understood that FIG. 2 provides the same interactivity with applications of the content providing device 125 as FIG. 1, though using a different implementation.

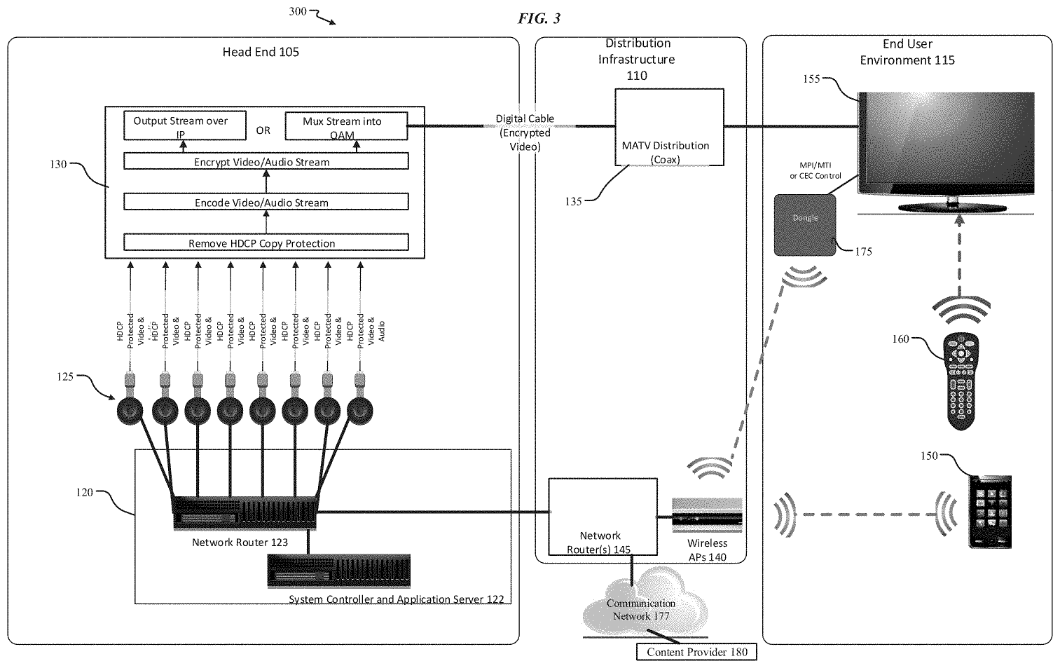

FIG. 3 is a block diagram depicting components of a system 300 in accordance with embodiments of the present disclosure. Here, it should be appreciated that FIG. 3 includes the same elements as FIG. 1, except that FIG. 3 does not include the keystroke router 124 and the terminal element 165. Instead, FIG. 3 shows that the end user environment includes a control device (e.g., a dongle) 175 that communicates wirelessly with the APs 140 to send information related to key input on the control instrument 160 and other information related to command and control of the display 155. According to at least one example embodiment, the control device 175 is compatible with message passing interface MPI (part of the message passing toolkit (MPT) and/or consumer electronics control (CEC) cables and standards. Upon receipt of user input on the display 155 and/or the control instrument 160, such input is wirelessly conveyed to the APs 140 and handled by the headend manager 120. As in FIG. 1, the system 300 delivers content from the headend 105 to the display(s) 155 through the MATV network 135. However, example embodiments are not limited thereto, and the system 300 may deliver content in a manner the same as or similar the system 200 in FIG. 2 using Ethernet. Here, it should be understood that FIG. 3 provides the same interactivity with applications of the content providing device 125 as FIGS. 1 and 2, though using a different implementation.

Here, it should be appreciated that various elements in the systems of FIGS. 1-3 may be combined with one another if desired. For example, the control device 175 in FIG. 3 may be implemented in the system of FIG. 2 if desired.

FIG. 4 is a block diagram illustrating an example structure of the system controller and application server 122 according to at least one example embodiment.

In general, the system controller and application server 122 includes a processor 405 and memory 410. The processor 405 may comprise a programmable processor or controller for executing application programming or instructions. As a further example, the processor 405 may comprise a specially configured application specific integrated circuit (ASIC). The processor 405 generally functions to run programming code and/or instructions, such as applications and/or programs, implementing various functions of the system controller and application server 122. The memory 410 may provide temporary and/or long-term storage of program instructions for execution by the processor 405 and/or data. The memory may also include one or more applications for execution by the processor 405. The memory 410 may comprise a removable secure digital storage, RAM, SDRAM, and/or other solid-state memory. Alternatively, or in addition, the memory 410 may comprise a hard disk drive or other random-access memory and/or can be interconnected to the system controller and application server 122, for example as network-attached storage.

The system controller and application server 122 may also include one or more communication interfaces 430A-B. For example, a first communication interface 430A may include hardware and/or software for providing wired and/or wireless connections to a first network including the headend 105, the distribution infrastructure 110, and the end user environment 115. Examples of the first communication interface 430A include an Ethernet interface, a coaxial cable interface, a Wi-Fi interface, etc. A second communication interface 430B may include hardware and/or software for providing wired and/or wireless connections to a second network, such as the communication network 177, for example, through the one or more network routers 140. Examples of the second communication interface 430B include an Ethernet interface, a coaxial cable interface, a Wi-Fi interface, etc. As shown, the components of the system controller and application server 122 may be coupled to one another via the bus 440 and powered by the power source 435.

FIG. 5 is a block diagram illustrating an example structure of the content providing device 125 according to at least one example embodiment.

In general, the content providing device 125 includes a processor 505 and memory 510. The processor 505 may comprise a programmable processor or controller for executing application programming or instructions. As a further example, the processor 505 may comprise a specially configured application specific integrated circuit (ASIC). The processor 505 generally functions to run programming code and/or instructions, such as applications and/or programs, implementing various functions of the content providing device 125. The memory 510 may provide temporary and/or long-term storage of program instructions for execution by the processor 505 and/or data. The memory may also include one or more applications (e.g., streaming applications, web browsers, etc.) for execution by the processor 505. The memory 510 may comprise flash memory, RAM, SDRAM, and/or other solid-state memory.

The content providing device 125 may also include one or more communication interfaces 530A-B. For example, a first communication interface 430A may include hardware and/or software for providing wired and/or wireless connections to headend manager 120 (e.g., the network router 123). Examples of the first communication interface 530A include an Ethernet interface, a coaxial cable interface, a Wi-Fi interface, etc. A second communication interface 530B may include hardware and/or software for providing wired and/or wireless connections to the converter 130. Examples of the second communication interface 530B include an Ethernet interface, a coaxial cable interface, a WiFi interface, an HDMI interface, an RCA interface, video graphics array (VGA) interface, digital visual interface DVI, etc. As shown, the components of the content providing device 125 may be coupled to one another via the bus 540 and powered by the power source 535.

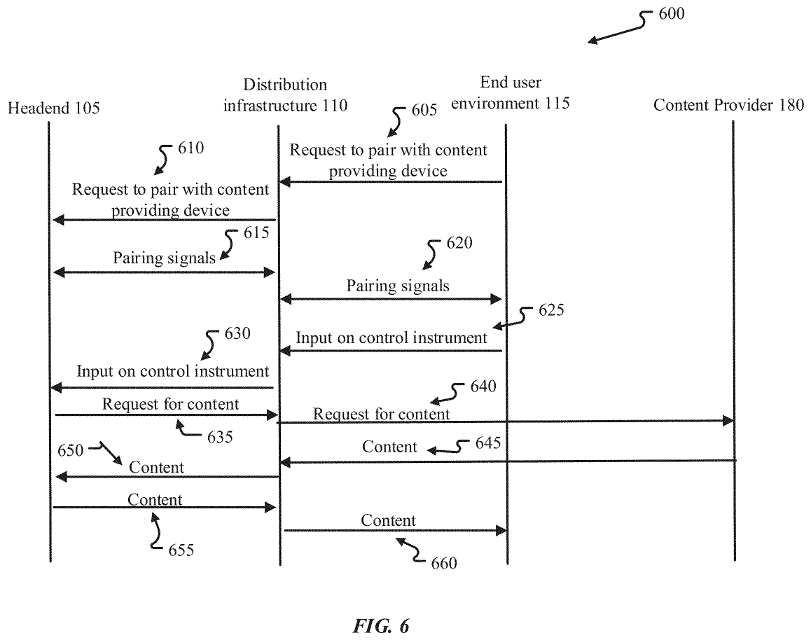

FIG. 6 illustrates a messaging diagram 600 in accordance with at least one example embodiment. In operation 605, the end user environment 115 sends a request to pair with a content providing device 125 to the distribution infrastructure 110. For example, a user sends the request with the control instrument 160 through the display device 155 or sends the request over a wireless connection using the mobile device 150.

In operation 610, the distribution infrastructure 110 forwards the request to the headend 105. For example, if using the system 100 of FIG. 1, the MATV system 135 receives the request from display 155 or the STB 165 or the wireless AP 140 receives the request from the mobile device 150 for pairing and forwards the request to the keystroke router 124 or the network router 123 depending on the implementation.

In operation 615, the headend 105 sends one or more pairing signals to the distribution infrastructure 110, and, in operation 620, the one or more pairing signals are forwarded by the distribution infrastructure 110 to the end user environment 115. For example, if using the system 100 of FIG. 1, the system controller and application server 122 sends the pairing signals to the display 155 through the MATV system 135 or to the mobile device 150 through the wireless APs 140. As indicated by the dual ended arrows, operations 615 and 620 may include messages traveling from the headend 105 to the end user environment 115 and vice versa to indicate the possibility of other signals (e.g., acknowledgement) being sent from the end user environment 115 to the headend 105 in response to receiving pairing information. The pairing signals/information may be signals in accordance with the pairing operations described above with reference to FIG. 1. After completion of operation 620, the end user environment 115 is paired with a selected content providing device 125 in the headend 105, which allows the end user environment 115 control over the selected content providing device 125. In general, pairing is allowed to occur if the end user environment 115 is authorized to access one of the content providing devices 125 and/or if one of the content providing devices 125 is available for use.

In operation 625, input may occur on the control instrument 160 to control at the end user environment 115. Such input is sent to the headend 105 in operation 630 through the distribution infrastructure 110. For example, if using the system of FIG. 1, the input is sent from the display 155 to MATV system 135 and forwarded to the keystroke router 124 for interpretation of the input in accordance with operations described above with respect to the keystroke router 124. In at least one example embodiment, the input may include a user request for content from the selected content providing device 125. Additionally or alternatively, the mobile device 150 may receive the user input and send the input to the headend 105 through a wireless AP 140.

Operations 635 and 640 include sending a request for content from the headend 105 to the content provider 180. For example, the system controller and application server 122 sends the request for content to the content provider 180 through the network router 123 of the headend 105 and the network router 145 of the distribution infrastructure 110 and the communication network 177. In operations 645 and 650, the content provider 180 returns content according to the request. For example, the content provider 180 sends audio and/or video to the system controller and application server 122 through the communication network 177 and the network router 145 of the distribution infrastructure 110 and the network router 123 of the headend 105.

In operation 655, the headend 105 sends the content received from the content provider 180 to the distribution infrastructure 110. For example, the system controller and application server 122 controls the selected content providing device 125 to send the content through the converter 130, and the converter 130 performs operations in accordance with those described above with respect to FIGS. 1-3 before sending the content to the distribution infrastructure 110.

In operation 660, the distribution infrastructure 110 sends the content to the end user environment 115 for listening and/or viewing at the display 155. Here, it should be further understood that at this stage, the mobile device 150 may be enabled for control of the content to the display 155 through the selected content providing device 125. In addition, the mobile device 150 may be enabled for casting content from the mobile device 150 to the display 155 through the selected content providing device 125.

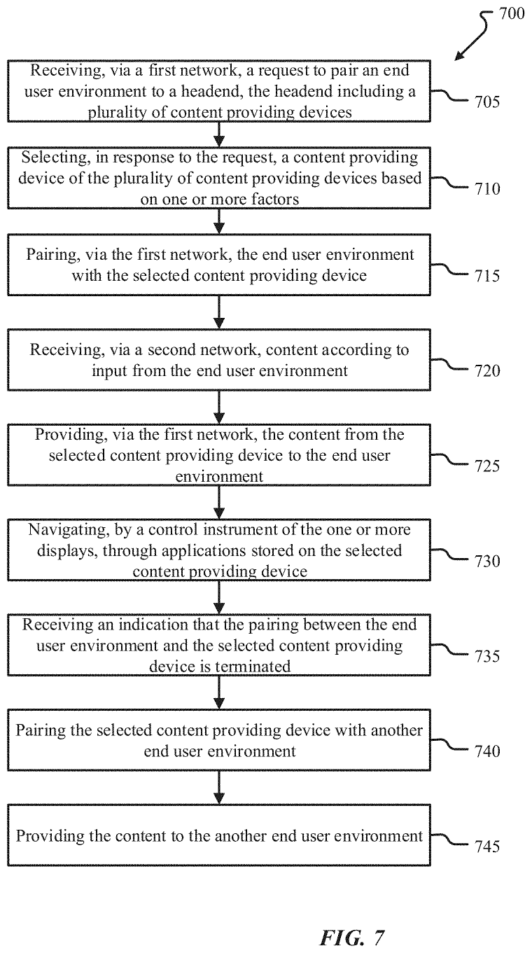

FIG. 7 is a flow chart illustrating a method 700 according to at least one example embodiment. The method 700 may be performed by one or more of the elements in the systems 100/200/300 in FIGS. 1-3. The operations in method 700 may be performed in a different order than that presented in FIG. 7 according to design preferences.

In operation 705, the method 700 includes receiving, via a first network, a request to pair an end user environment 115 to a headend 105. The headend 105 includes a plurality of content providing devices 125. Here, the first network may be a network facilitating communication between the headend 105, the distribution infrastructure 110, and the end user environment 115. The request to pair with the headend 105 may be a request from a user in control of the control instrument 160 and/or the mobile device 150.

In operation 710, the method 700 includes selecting, in response to the request, a content providing device 125 of the plurality of content providing devices 125 based on one or more factors. In at least one example embodiment, the one or more factors include an availability of the plurality of content providing devices 125 and/or an authorization level of the end user environment 115. For example, the system network controller and application server 122 may determine whether all of the content providing devices 125 are in use. If all content providing devices 125 are in use, then the system network controller and application server 122 may return an error message to the end user environment 115 indicating that a content providing device 125 is not available. If all content providing devices 125 are not in use, then additionally, the system network controller and application server 122 may attempt to authorize the end user environment 115. For example, the end user environment 115 may send, along with or in addition to the pairing request, authorization information of the end user environment 115 so that the headend 105 can ensure that the request is a legitimate request. For example, the memory 410 of the system network controller and application server 122 may include an updatable table that stores authorization information specific to each end user environment. The authorization information may include any information usable to authorize that the request is a legitimate request such as a phone number of the user making the request, a code associated with and available at the end user environment 115, etc. The system network controller and application server 122 may compare authorization information received from the end user environment 115 to the table, and if there is a match in the table, a content providing device 125 is selected and the method proceeds to operation 715. If there is not a match, the system network controller and application server 122 may send an error message to the end user environment 115 that the user or end user environment 115 is not authorized and then may terminate communication.

In at least one example embodiment, the content providing devices 125 may include differently branded devices for supplying content (e.g., Apple TVs, Google Chromecasts, etc.). Thus, the one or more factors for selecting a content providing device 125 may include whether any of the content providing devices 125 are compatible with the user interface used at the end user environment 115. For example, the headend 105 checks whether a content providing device 125 is compatible with a mobile device 150 by comparing respective operating systems (OS) and/or by comparing whether the mobile device 150 includes an application or interface that is compatible with the content providing device 125. If so, then selection of a content providing device 125 continues, and if not, the headend 105 returns an error message to the end user environment 115 that no compatible content providing device 125 is available. Additionally or alternatively, the headend 105 (e.g., the system controller and application server 122) may include hardware and/or software (e.g., a driver) that consolidates multiple incompatible consumer technologies into a uniform experience/user interface for each end user environment 115. In this case, the user experience to pair the mobile device 150 with the system would be consistent across multiple end user environments 115 to allow the user to cast using different technologies (e.g., Apple's AirPlay, Google Cast, etc.).

Here, it should be understood that the authorization information may also include information regarding a level of access to the selected content providing device 125 that is made available to the end user environment 115. For example, it may be desirable to restrict and/or grant access to certain applications of the selected content providing device 125 based on a loyalty level of a user (e.g., in the case of a hotel environment). Thus, the authorization information may include information to restrict and/or grant access to certain applications of the content providing device 125 to place limits on types of content available to the end user environment 115.

Operation 715 includes pairing, via the first network, the end user environment 115 with the selected content providing device 125. The pairing in operation 715 occurs according to the pairing operations described above.

Operation 720 includes receiving, via a second network, content according to input from the end user environment 115. The second network may be separate from the first network and may include the content provider 180 and the communication network 177. Content may be received by the system network controller and application server 122 from the communication network 177 in any known manner.

Operation 725 includes providing, via the first network, the content from the selected content providing device 125 to the end user environment 115. For example, the content may be sent from the system network controller and application server 122 to one or more displays 155 in accordance with operations described above with reference to FIGS. 1-6. The end user environment 115 may include a mobile device 150. In this case, operation 725 may include the mobile device 150 controlling the selected content providing device 125 to provide the content to the one or more displays 155.

Operation 730 may include navigating, by a control instrument 160 of the one or more displays 155, through applications stored on the selected content providing device 125. For example, the input in operation 720 may include user input on the control instrument 160. In this case, the navigating includes interpreting, by the headend 105, the input on the control instrument 160 (e.g., by the keystroke router 124 and/or the system network controller and application server 122). In the system 300 of FIG. 3, the navigating includes interpreting, by a control device 175 at the end user environment 115, the input on the control instrument 160 and sending the interpreted input to the wireless APs 140. In this case, there may be an additional operation of wirelessly communicating, by the control device 175, the input to one or more network elements (e.g., APs 140) coupled to the headend 105.

Operation 735 may include receiving an indication that the pairing between the end user environment 115 and the selected content providing device 125 is terminated. For example, the indication may be in response to a user at the end user environment 115 terminating session with the selected content providing device 125 via the control instrument 160 and/or the mobile device 150. Additionally or alternatively, the indication may be in response to an amount of time that has elapsed since pairing and/or receiving content (e.g., two hours), in response to an elapsed time since detecting input at the control instrument 160 and/or the mobile device 150, etc. Following termination of the pairing between the end user environment 115 and the selected content device 125, the method may proceed to operation 730.

Operation 730 includes pairing the selected content providing device 125 with another end user environment 115. Operation 735 includes providing the content to the another end user environment 115. Operations 730 and 735 may occur in the same manner as the pairing and providing operations described above for the initial end user environment 115.

In view of the above, it should be understood that at least one example embodiment includes a system including a plurality of content providing devices 125, an end user environment 115, and a headend 105 in communication with the end user environment 115 and the plurality of content providing devices 125. The headend 105 is configured to receive, via a first network (including 105/110/115), a request to pair the end user environment 115 with one of the plurality of content providing devices 125. The headend 105 selects, in response to the request, a content providing device 125 of the plurality of content providing devices 125 based on one or more factors. The headend 105 pairs, via the first network, the end user environment 115 with the selected content providing device 125. The headend 105 receives, via a second network 177, content according to input from the end user environment 115, and provides, via the first network, the content from the selected content providing device 125 to the end user environment 115.

In at least one example embodiment, the end user environment 115 includes a mobile device 150, and the headend 105 enables the mobile device 150 to control the selected content providing device 125 to provide the content to one or more displays 155.

In at least one example embodiment, the system includes a control system associated with the one or more displays 155, where the control system enables navigation through applications stored on the selected content providing device 125. The control system may include a control instrument 160 in communication with the one or more displays 155, and a keystroke router 124 in communication with the one or more displays 155 and the headend 105. The input includes input on the control instrument 160, and the keystroke router 124 interprets the input on the control instrument 160.

In at least one example embodiment, the end user environment further comprises a control device 175 connected to the one or more displays 155, and the control device 175 interprets the input on the control instrument 160. The control device 175 wirelessly communicates the input to one or more network elements 140 coupled to the headend 105.

In at least one example embodiment, the headend 105 receives an indication that the pairing between the end user environment 115 and the selected content providing device 125 is terminated, pairs the selected content providing device 125 with another end user environment 115, and provides the content to the another end user environment 115.

At least one example embodiment includes a headend 105 including a plurality of content providing devices 125 and a controller 122 coupled to the plurality of content providing devices 125. The headend 105 may include a converter 130 configured to remove copy protection (e.g., HDCP) from an audio/video signal of the content, encode and encrypt the audio/video signal, and provide the encoded and encrypted audio/video signal to the end user environment 115. The converter 130 may encode the content with a different encoding scheme than used for the content prior to reaching the converter 130. Similarly, the converter 130 may encrypt the content with a different encryption scheme than used for the content prior to reaching the converter 130.

In view of the above, it should be appreciated that example embodiments provide a solution that allows headend based casting and interactivity on the same hardware rather than requiring different hardware for casting and interactives. In addition, example embodiments provide for sharing of content providing devices over a large number of possible users, for example, in a hospitality environment. It should be appreciated that example embodiments are not limited to hospitality environments and may be applied to any environment where it is desirable to share content providing devices over multiple end user environments.

At least one example embodiment is directed to a method that includes receiving, via a first network, a request to pair an end user environment to a headend. The headend includes a plurality of content providing devices. The method includes selecting, in response to the request, a content providing device of the plurality of content providing devices based on one or more factors. The method includes pairing, via the first network, the end user environment with the selected content providing device. The method includes receiving, via a second network, content according to input from the end user environment, and providing, via the first network, the content from the selected content providing device to the end user environment.

According to at least one example embodiment, the end user environment includes one or more displays to which the content is provided.

According to at least one example embodiment, the end user environment includes a mobile device, and the providing includes the mobile device controlling the selected content providing device to provide the content to the one or more displays.

According to at least one example embodiment, the method further comprises navigating, by a control instrument of the one or more displays, through applications stored on the selected content providing device.

According to at least one example embodiment, the input includes input on the control instrument, and the navigating includes interpreting, by the headend, the input on the control instrument.

According to at least one example embodiment, the input includes input on the control instrument, and the navigating includes interpreting, by a control device at the end user environment, the input on the control instrument.

According to at least one example embodiment, the method includes wirelessly communicating, by the control device, the input to one or more network elements coupled to the headend.

According to at least one example embodiment, the one or more factors include an availability of the plurality of content providing devices and an authorization level of the end user environment.

According to at least one example embodiment, the method includes receiving an indication that the pairing between the end user environment and the selected content providing device is terminated, pairing the selected content providing device with another end user environment, and providing the content to the another end user environment.

According to at least one example embodiment, a system includes a plurality of content providing devices, an end user environment, and a headend in communication with the end user environment and the plurality of content providing devices. The headend is configured to receive, via a first network, a request to pair the end user environment with one of the plurality of content providing devices. The headend is configured to select, in response to the request, a content providing device of the plurality of content providing devices based on one or more factors. The headend is configured to pair, via the first network, the end user environment with the selected content providing device. The headend is configured to receive, via a second network, content according to input from the end user environment, and provide, via the first network, the content from the selected content providing device to the end user environment.

According to at least one example embodiment, the end user environment includes one or more displays to which the content is provided.

According to at least one example embodiment, the end user environment includes a mobile device, and the headend enables the mobile device to control the selected content providing device to provide the content to the one or more displays.

According to at least one example embodiment, the system includes a control system associated with the one or more displays, the control system enabling navigation through applications stored on the selected content providing device.

According to at least one example embodiment, the control system includes a control instrument in communication with the one or more displays, and a keystroke router in communication with the one or more displays and the headend. The input includes input on the control instrument, and the keystroke router interprets the input on the control instrument.

According to at least one example embodiment, the end user environment further comprises a control device connected to the one or more displays, and the input includes input on the control instrument. The control device interprets the input on the control instrument.

According to at least one example embodiment, the control device wirelessly communicates the input to one or more network elements coupled to the headend.

According to at least one example embodiment, the one or more factors include an availability of the plurality of content providing devices and an authorization level of the end user environment.

According to at least one example embodiment, the headend receives an indication that the pairing between the end user environment and the selected content providing device is terminated, pairs the selected content providing device with another end user environment, and provides the content to the another end user environment.

At least one example embodiment is directed to a headend, comprising a plurality of content providing devices, and a controller coupled to the plurality of content providing devices. The controller receives, via a first network, a request to pair an end user environment with one of the plurality of content providing devices. The controller selects, in response to the request, a content providing device of the plurality of content providing devices based on one or more factors. The controller pairs, via the first network, the end user environment with the selected content providing device. The controller receives, via a second network, content according to input from the end user environment. The controller provides, via the first network, the content from the selected content providing device to the end user environment.

According to at least one example embodiment, the headend further comprises a converter configured to remove copy protection from an audio/video signal of the content, encode and encrypt the audio/video signal, provide the encoded and encrypted audio/video signal to the end user environment.

Example embodiments have been described with some degree of particularity. It should be appreciated though that modifications or changes may be made to the exemplary embodiments without departing from the inventive concepts contained herein.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section(s) 112(f) and/or 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

It is claimed:

1. A method, comprising:
receiving, via a first network, a request to pair an end user environment to a headend, the headend including a plurality of content providing devices;
selecting, in response to the request, a content providing device of the plurality of content providing devices based on one or more factors;
pairing, via the first network, the end user environment with the selected content providing device;
receiving, via a second network, content according to input from the end user environment; and
providing, via the first network, the content from the selected content providing device to the end user environment.

2. The method of claim 1, wherein the end user environment includes one or more displays to which the content is provided.

3. The method of claim 2, wherein the end user environment includes a mobile device, wherein the providing includes the mobile device controlling the selected content providing device to provide the content to the one or more displays.

4. The method of claim 3, further comprising:
navigating, by a control instrument of the one or more displays, through applications stored on the selected content providing device.

5. The method of claim 4, wherein the input includes input on the control instrument, and wherein the navigating includes interpreting, by the headend, the input on the control instrument.

6. The method of claim 4, wherein the input includes input on the control instrument, and wherein the navigating includes interpreting, by a control device at the end user environment, the input on the control instrument.

7. The method of claim 6, further comprising:
wirelessly communicating, by the control device, the input to one or more network elements coupled to the headend.

8. The method of claim 1, wherein the one or more factors include an availability of the plurality of content providing devices and an authorization level of the end user environment.

9. The method of claim 1, further comprising:
receiving an indication that the pairing between the end user environment and the selected content providing device is terminated;
pairing the selected content providing device with another end user environment; and
providing the content to the another end user environment.

10. A system, comprising:
a plurality of content providing devices;
an end user environment; and
a headend in communication with the end user environment and the plurality of content providing devices, the headend being configured to:
receive, via a first network, a request to pair the end user environment with one of the plurality of content providing devices;
select, in response to the request, a content providing device of the plurality of content providing devices based on one or more factors;
pair, via the first network, the end user environment with the selected content providing device;
receive, via a second network, content according to input from the end user environment; and
provide, via the first network, the content from the selected content providing device to the end user environment.

11. The system of claim 1, wherein the end user environment includes one or more displays to which the content is provided.

12. The system of claim 11, wherein the end user environment includes a mobile device, wherein the headend enables the mobile device to control the selected content providing device to provide the content to the one or more displays.

13. The system of claim 12, further comprising:
a control system associated with the one or more displays, the control system enabling navigation through applications stored on the selected content providing device.

14. The system of claim 13, wherein the control system includes:
a control instrument in communication with the one or more displays; and
a keystroke router in communication with the one or more displays and the headend, wherein the input includes input on the control instrument, and wherein the keystroke router interprets the input on the control instrument.

15. The system of claim 13, wherein the end user environment further comprises:
a control device connected to the one or more displays, wherein the input includes input on the control instrument, and wherein the control device interprets the input on the control instrument.

16. The system of claim 15, wherein the control device wirelessly communicates the input to one or more network elements coupled to the headend.

17. The system of claim 10, wherein the one or more factors include an availability of the plurality of content providing devices and an authorization level of the end user environment.

18. The system of claim 10, wherein the headend receives an indication that the pairing between the end user environment and the selected content providing device is terminated, pairs the selected content providing device with another end user environment, and provides the content to the another end user environment.

19. A headend, comprising:
a plurality of content providing devices; and
a controller coupled to the plurality of content providing devices and that:
receives, via a first network, a request to pair an end user environment with one of the plurality of content providing devices;
selects, in response to the request, a content providing device of the plurality of content providing devices based on one or more factors;
pairs, via the first network, the end user environment with the selected content providing device;
receives, via a second network, content according to input from the end user environment; and
provides, via the first network, the content from the selected content providing device to the end user environment.

20. The headend of claim 19, further comprising:
a converter configured to:
remove copy protection from an audio/video signal of the content;
encode and encrypt the audio/video signal; and
provide the encoded and encrypted audio/video signal to the end user environment.
